(19) United States
(12) Patent Application Publication
(10) Pub. No.: US 2002/0061058 A1
(43) Pub. Date: May 23, 2002

(54) Subscriber loop repeater loopback for fault isolation

(75) Inventor: Jeremy Sommer, Mountain View, CA (US)

Correspondence Address: FULBRIGHT & JAWORSKI L.L.P., 600 CONGRESS AVENUE, SUITE 2400, AUSTIN, TX, 78701, US

(73) Assignee: SYMMETRICOM, INC.

(21) Appl. No.: 09/882,288

(22) Filed: Jun. 14, 2001

Related U.S. Application Data
(60) Provisional application No. 60/220,640, filed on Jul. 25, 2000.

(51) Int. Cl. H04B 17/02

(52) U.S. Cl. 375/213

(57) ABSTRACT

Systems and methods are described for subscriber loop repeater loopback for fault isolation. A method includes obtaining a sample of a downstream signal conveyed along a signal path; performing an analysis of the sample; determining a presence or an absence of a fault in the signal path based on the analysis of the sample; indicating a presence or an absence of a fault in the signal path by transmitting a diagnostic signal to an upstream node; and isolating a location of the fault as a function of the diagnostic signal. An apparatus includes a band pass filter; a detection unit coupled to the first band pass filter; a data processor coupled to the detection unit; a health checking unit coupled to the microcontroller; a digital to analog converter coupled to the microcontroller; a low pass filter coupled to the digital to analog converter; and a summer coupled to the low pass filter.

### CROSS-REFERENCE TO RELATED APPLICATION

This application is related to, and claims a benefit of priority under 35 U.S.C. 119(e) and/or 35 U.S.C. 120 of copending U.S. Ser. No. 60/220,640, filed Jul. 25, 2000, now pending, the entire contents of which are hereby incorporated by reference for all purposes.

### BACKGROUND OF THE INVENTION

1. Field of the Invention

The invention relates generally to the field of communications. More particularly, the invention relates to digital subscriber loop (DSL) communications. Specifically, a preferred implementation of the invention relates to extending the range of an asymmetric digital subscriber loop (ADSL). The invention thus relates to ADSL of the type that can be termed extended.

2. Discussion of the Related Art

Conventional telephony, often called plain old telephone service (POTS), is provided to customers over copper cable. This copper cable can be termed a subscriber loop or a subscriber line. Modem loop plant designs specify the use of 26-gauge cable for short to medium loop lengths with 24-gauge cable used to extend the range. Legacy loop plant includes cable of 22-gauge as well as 19-gauge.

At the customer premises, a telephone set is typically connected to the cable. The other end of the cable is connected to a line circuit module in the service provider's central office (CO). Switches terminating customer loops at the central office are regarded as Class-5 switches and provide a dial-tone. The customer premise equipment (CPE) can include a personal computer (PC) modem.

Older central office switches were analog in nature and were unable to provide a broad range of services. Modem central office switches are digital. Digital switches include codecs in the line circuit to do the bilateral analog-digital (A/D) conversion; the transmission over the loop is analog and the signals occupy a frequency band of up to (approximately) 4 kHz. Conventional telephony codecs convert at an 8 kHz sampling rate and quantize to 8 bits per sample corresponding to a net bit rate of 64 kbps (or “DS0”).

With the advent of digital terminal equipment, such as personal computers, modems were developed to carry digital bit streams in an analog format over the cable pair. Because of the 4 kHz constraint imposed by the A/D converter in the line circuit, the data rate of such transmission is limited and is typically 9.6 kbps. More elaborate schemes have been proposed which permit higher bit rates (e.g. V.34 which can do in excess of 28.8 kbps). More recently, there are schemes that “spoof” the D/A converter in the line-circuit and operate at bit rates as high as 56 kbps in the downstream direction (from CO to CPE). With increasing deployment of, and consequently demand for, digital services it is clear that this bit rate is insufficient.

An early proposal to increase the information carrying capacity of the subscriber loop was ISDN (“Integrated Services Digital Network”), specifically the BRI (“Basic Rate Interface”) which specified a “2B+D” approach where 2 bearer channels and one data channel (hence 2B+D) were transported between the CO and the CPE. Each B channel corresponded to 64 kbps and the D channel carried 16 kbps. With 16 kbps overhead, the loop would have to transport 160 kbps in a full duplex fashion. This was the first notion of a Digital Subscriber Loop (“DSL”) (or Digital Subscriber Line). However, this approach presumed that POTS and 2B+D would not coexist (simultaneously). The voice codec would be in the CPE equipment and the “network” would be “all-digital”. Most equipment was designed with a “fall-back” whereby the POTS line-circuit would be in a “stand-by” mode and in the event of a problem such as a power failure in the CPE, the handset would be connected to the loop and the conventional line-circuit would take over. There are several ISDN DSLs operational today.⁽¹⁻²⁾

Asymmetric digital subscriber loop (ADSL) was proposed to provide a much higher data rate to the customer in a manner that coexisted with POTS. Recognizing that the spectral occupancy of POTS is limited to low frequencies, the higher frequencies could be used to carry data (the so-called Data over Voice approach). Nominally, ADSL proposed that 10 kHz and below would be allocated to POTS and the frequencies above 10 kHz for data. Whereas the nominal ADSL band is above 10 kHz, the latest version of the standard specifies that the “useable” frequency range is above 20 kHz. This wide band between 4 kHz and the low edge of the ADSL band simplifies the design of the filters used to segregate the bands.

Furthermore, it was recognized that the downstream data rate requirement is usually much greater than the upstream data rate requirement. Several flavors (“Classes”) of ADSL have been standardized, involving different data rates in the two directions. The simplest is Class-4 which provides (North American Standard) 1.536 Mbps in the downstream direction and 160 kbps in the upstream direction. The most complicated, Class-1, provides about 7 Mbps downstream and 700 kbps upstream.⁽³⁻⁴⁾

A stumbling block in specifying, or guaranteeing, a definite bit rate to a customer is the nature of the loop plant. Customers can be at varied geographical distances from the central office and thus the length of the subscriber loop is variable, ranging from short (hundreds of feet) to long (thousands of feet) to very long (tens of thousands of feet). The essentially lowpass frequency response of subscriber cable limits the usable bandwidth and hence the bit rate.

Moreover, loops longer than (approximately) 18 thousand feet have a lowpass characteristic that even affects the voiceband. Such loops are specially treated by the addition of load coils and are called “loaded loops”. The principle is to splice in series-inductors which have the impact of “boosting” the frequency response at (approximately) 4 kHz with the secondary effect of increasing the attenuation beyond 4 kHz very substantially. In these loaded loops, the spectral region above 10 kHz is unusable for reliable transmission. Consequently, the categorical statement can be made that DSL (including ADSL, “2B+D”, and other flavors of DSL) cannot be provided over long loops and definitely cannot be provided over loaded loops.

Heretofore, there has not been a completely satisfactory approach to providing DSL over long loops. Further, there has not been a satisfactory approach to providing DSL over loaded loops. What is needed is a solution that addresses one, or both, of these requirements. The invention is directed to meeting these requirements, among others.

### SUMMARY OF THE INVENTION

There is a need for the following embodiments. Of course, the invention is not limited to these embodiments.

One embodiment of the invention is based on a method, comprising: obtaining a sample of a downstream signal conveyed along a signal path; performing an analysis of the sample; determining a presence or an absence of a fault in the signal path based on the analysis of the sample; indicating a presence or an absence of a fault in the signal path by transmitting a diagnostic signal to an upstream node; and isolating a location of the fault as a function of the diagnostic signal. Another embodiment of the invention is based on an apparatus, comprising: a band pass filter; a detection unit coupled to the first band pass filter; a data processor (e.g. a microcontroller) coupled to the detection unit; a health checking unit coupled to the microcontroller; a digital to analog converter coupled to the microcontroller; a low pass filter coupled to the digital to analog converter; and a summer coupled to the low pass filter.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a block schematic view of the more important components of an ADSL repeater equipped subscriber loop, representing an embodiment of the invention.

FIG. 2 illustrates a block schematic view of the more important elements of a DMT signal processing flow (echo canceling mode), representing an embodiment of the invention.

FIG. 3 illustrates a block schematic view of a frequency-division duplexing mode for DMT-based ADSL (central office end shown), representing an embodiment of the invention.

FIG. 4 illustrates a block schematic view of an exemplary asymmetric digital subscriber loop repeater, representing an embodiment of the invention.

FIG. 5 illustrates a block schematic view of an outline of an extender circuit, representing an embodiment of the invention.

FIG. 6 illustrates a block schematic view of function blocks of fault-location tone generation in a repeater, representing an embodiment of the invention.

FIG. 7 illustrates a block schematic view of an ADSL repeater, representing an embodiment of the invention.

FIG. 8 illustrates a flowchart view of an autonomous loopback, representing an embodiment of the invention.

FIG. 9 illustrates a simplified block schematic view of a non-autonomous loopback state machine, representing an embodiment of the invention.

FIG. 10 illustrates a flowchart view of a first part of a non-autonomous loopback, representing an embodiment of the invention.

FIG. 11 illustrates a flowchart view of a second part of a non-autonomous loopback, representing an embodiment of the invention.

FIG. 12 illustrates a flowchart view of a third part of a non-autonomous loopback, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

Within this application several publications are referenced by Arabic numerals within parentheses or brackets. Full citations for these, and other, publications may be found at the end of the specification immediately preceding the claims after the section heading References. The disclosures of all these publications in their entireties are hereby expressly incorporated by reference herein for the purpose of indicating the background of the invention and illustrating the state of the art.

The below-referenced U.S. Patent Applications disclose embodiments that were satisfactory for the purposes for which they are intended. The entire contents of U.S. patent application Ser. No. 09/476,770, filed Jan. 3, 2000; U.S. patent application Ser. No. 09/821,841, filed Mar. 28, 2001 (attorney docket no. SYMM:029US); U.S. patent application Ser. No. 09/836,889, filed Apr. 16, 2001 (attorney docket no. SYMM:032US); U.S. patent application Ser. No. 09/838,575, filed Apr. 19, 2001 (attorney docket no. SYMM:033US); U.S. patent application Ser. No. 09/843,161, filed Apr. 25, 2001 (attorney docket no. SYMM:031US); and U.S. patent application Ser. No. 09/______, filed______, 2001 (attorney docket no. SYMM:034US) are hereby expressly incorporated by reference herein for all purposes.

The context of the invention includes digital subscriber loops. One species of digital subscriber loops is an asymmetrical digital subscriber loop. A preferred embodiment of the invention using ADSL repeaters (in place of load coils) enables a form of ADSL that uses the technique of frequency-division-duplexing to be provided to customers over very long loops.

The agreed upon standard for ADSL is the DMT (Discrete Multi-Tone) method. A premise underlying DMT is that the channel, namely the subscriber loop, does not have a “flat” frequency response. The attenuation at 1 Mhz (“high” frequency) can be as much as 60 dB greater than at 10 kHz (“low” frequency). Furthermore this attenuation varies with the length of the cable. By using Digital Signal Processing (“DSP”) techniques, specifically the theory of the Discrete Fourier Transform (“DFT”) and Fast Fourier Transform (“FFT”) for efficient implementation, the DMT method splits the available frequency band into smaller sub-channels of (approximately) 4 kHz. Each sub-channel is then loaded with a data rate that it can reliably support to give the desired aggregate data rate. Thus lower (center-)frequency sub-channels will normally carry a greater data rate than the sub-channels at higher (center-)frequencies.

The underlying principle of the DSL repeater is the need to combat the loss in the actual cable (subscriber loop). This is achieved by introducing gain. Since amplifiers are for the most part uni-directional devices, one approach is to perform a 2w-to-4w conversion and put amplifiers in each direction. This is most easily achieved when the directions of transmission are in disjoint spectral bands. That is, if the directions of transmission are separated in frequency (i.e. frequency-division duplexing), then simple filter arrangements can provide the separation.

Most loop plant provides for access to the cable, which may be buried underground, approximately every 6000 feet. This was the practice to allow for the provision of load coils. Thus the natural separation between repeaters is (approximately) 6000 feet. The repeater may be placed in parallel with a load coil if the DSL needs to coexist with POTS.

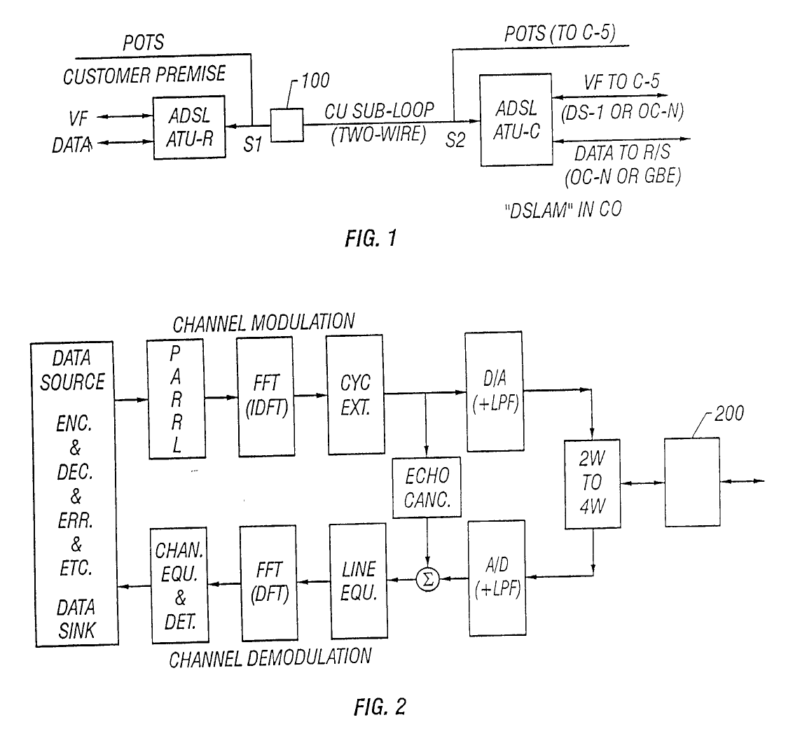

Referring to FIG. 1, a general architecture for providing an asymmetric digital subscriber loop (ADSL) is depicted. A subscriber loop is the actual two-wire copper pair that originates at the Central Office and terminates at the subscriber's premise. For providing ADSL over long loops, an ADSL repeater, 100, may be included. At the customer premise the handset (POTS) is “bridged” onto the subscriber loop at point labeled S1. In some forms of ADSL this bridging can be achieved using passive filters (called a “splitter”) to demarcate the frequency bands where voice and data reside. Similarly, a splitter may be employed at the central office (CO) at point S2. Central office equipment that interfaces to ADSL provisioned lines is often embodied as a multiplexer called a “DSLAM” (Digital Subscriber Line Access Multiplexer). The data component is aggregated into an optical or high-bit-rate signal for transport to the appropriate terminal equipment. The capacity of ADSL allows for additional voice circuits (shown as VF in FIG. 1) to be carried in digital format as part of the ADSL data stream. This content is usually (though not always) destined for a Class-5 switch.

The term approximately, as used herein, is defined as at least close to a given value (e.g., preferably within 10% of, more preferably within 1% of, and most preferably within 0.1% of). The term coupled, as used herein, is defined as connected, although not necessarily directly, and not necessarily mechanically. The term substantially, as used herein, is defined as at least approaching a given state (e.g., preferably within 10% of, more preferably within 1% of, and most preferably within 0.1% of).

Given that a large installed loop plant exists, the invention can include retrofit installation. Part of the retrofit installation procedure involves removal of all load coils, and bridge-taps that may be present on the (existing) subscriber loop. Based on telephone company records, the (approximate) distance between the subscriber premise and the serving Central Office can be estimated to decide whether DSL can be provided in the first place. If DSL can indeed be provided, an estimate of the class (and thus the data carrying capacity) is made. If not, then the telephone company may choose to provide a lower bit-rate service such as BRI or, in some cases, not be able to provide any service beyond POTS.

Signals from both directions can coexist on the cable pair and such transmission is referred to as “2-wire”. This form is perfectly adequate for analog signals (speech). In digital transmission systems the two directions are separated (logically, if not physically) and such transmission is termed “4-wire”. Two common approaches to achieving this action are “echo canceling” and frequency-division-duplexing (“FDD”). Both approaches can be supported by the DMT method.

Referring to FIG. 2, a signal processing flow in a DMT-based ADSL transmission unit (“ATU”) that employs echo cancellation is depicted. The transmit (“modulation” direction) side is considered first. The data to be transmitted is first processed to include error correction by a ENC. & DEC. & ERR. & ETC. unit. It is then formatted into multiple “parallel” channels via a PARRL processing unit, and it is placed in the appropriate frequency slots. The data is further processed via an FFT processing unit. The notion of “cyclic extension” is unique to DMT and involves increasing the sampling rate by insertion of additional samples via a CYC. EXT. processing unit. This composite signal is converted to analog via a D/A converter and coupled to the line via a 2w-to-4w converter. An ADSL repeater 200 is coupled to the 2w-to-4w converter.

Ideally the entire signal from the D/A converter is transmitted to the distant end via the 2w-to-4w converter. However, in practice some amount “leaks” from the 2w-to-4w converter toward a A/D converter. This leakage can be termed the “echo.”

The receive side (“demodulation” direction) is now considered. The signal from the distant end arrives at the 2w-to-4w converter via the repeater 200 and is directed to the A/D converter for conversion to digital format. Subsequent processing includes line equalization via the LINE EQU. unit, fast Fourier transformation via the FFT unit and then channel equalization and data detection via the CHAN. EQU. & DET. unit. Processing is then handed to the unit that does the error detection and/or correction and reorganizing into the appropriate format. To remove the echo (the component of the transmit signal that leaks across the 2w-to-4w converter) an echo cancellation filter is employed. This is a digital filter that mimics the echo path and thus the output of the filter labeled “Echo Canc” is a “replica” of the echo and by subtraction of this signal from the received signal at a summation unit, the net echo can be substantially reduced. Thus 4w operation is achieved even though the medium is merely 2w. The spectral content of signals in the two directions can have significant overlap but are sufficiently separated by the echo cancellation technique.

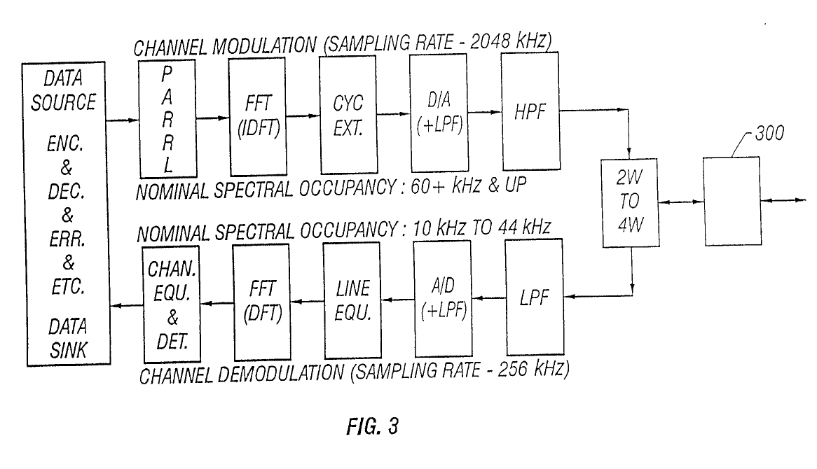

Referring to FIG. 3, a frequency-division duplexing (FDD) mode of DMT for ADSL is depicted. The “back-end” of the FDD version of DMT-based ADSL is substantially the same as the echo-canceling version illustrated in FIG. 2.

Referring again to FIG. 3, the frequency range used for Upstream versus Downstream is vendor specific. Standards-compliant ADSL uses a total bandwidth of roughly 20 kHz to 1.1 MHz. In a preferred embodiment, the upstream occupies between 20 kHz and X₁ kHz whereas the downstream signal occupies the band between X₂ kHz and 1.1 MHz. X₂ should be substantially greater than X₁ to allow for frequency roll-off of the filters used to demarcate the upstream and down-stream bands. One suitable choice is X₁=110 kHz and X₂=160 kHz. The specific choice of these band edges can be made a design parameter and different “models” of the repeater can be fabricated with different choices of band edges.

Still referring to FIG. 3, a high pass filter HPF unit is coupled to the D/A units. A 2w-to-4w converter is coupled to the HPF unit. The 2w-to-4w converter is also coupled to a low pass filter LPF unit which is in-turn coupled to the A/D unit. An ADSL repeater 300 is coupled to the 2w-to-4w converter.

The underlying principle of the ADSL extender is the need to combat the loss in the actual cable (subscriber loop). This is achieved by introducing gain. Since amplifiers are for the most part unidirectional devices, we need to, in essence, perform a 2w-to-4w conversion and put amplifiers in each direction. This is most easily achieved when the directions of transmission are in disjoint spectral bands. That is, if the directions of transmission are separated in frequency (i.e. frequency-division duplexing), then simple filter arrangements can provide the separation.

Most loop plant provide for access to the cable, which may be buried underground, approximately every 6000 feet. This was the practice to allow for the provision of load coils. Thus, the natural separation between repeaters is (approximately) 6000 feet. The repeater may be placed in parallel with a load coil if the ADSL needs to coexist with POTS.

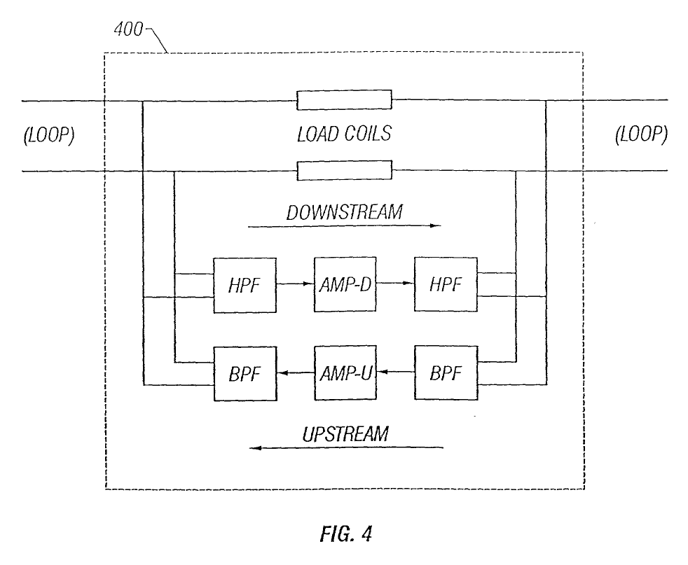

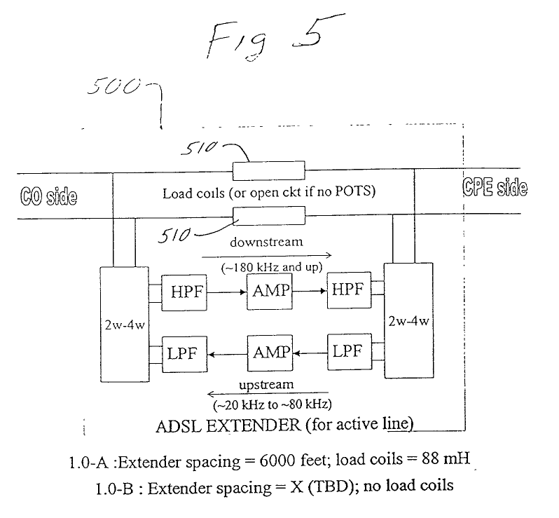

The particular description of an ADSL repeater provided in FIG. 4 is suitable for the DMT-based ADSL transmission scheme employing frequency-division duplexing (FDD). The form discussed assumes that POTS and ADSL will coexist (simultaneously). Of course, the invention is not limited to this ADSL FDD example.

Referring to FIG. 4, an outline of the functional blocks in an ADSL repeater 400 are depicted. For convenience certain functions such as power and control are not shown in FIG. 4. Power and control units can be coupled to the ADSL repeater 400. Although not required, two load coils are shown as part of the repeater 400. When load coils are deployed in a loop, the loop is split and the load coils are spliced in as indicated by the series connections of the inductors (load coils) with the loop. This can be termed in line with loop.

The load coils provide a very high impedance at high frequencies and thus for the range of frequencies where ADSL operates the load coils look essentially like open circuits. The 2w-to-4w arrangement is not explicitly shown in FIG. 4 but is implied. Since the two directions are separated in frequency, the 2w-to-4w arrangement can be quite simple. A bandpass filter BPF isolates the frequency band from 20 kHz to 110 kHz (approximately) and thus the upstream signal is amplified by an amplifier AMP-U. In this particular example, the gain introduced can compensate for the attenuation introduced by approximately 6000 feet of cable at 27 kHz (or approximately the middle of the band). The highpass filters HPF separates out the band above 160 kHz (approximately) and thus the downstream signal is amplified by an amplifier AMP-D. Again, in this particular example, the gain introduced compensates for the attenuation of approximately 6000 feet of cable at 600 kHz (again, roughly the middle of the band).

Since the frequency response of the cable is not “flat” the amplifiers can be designed such that, in conjunction with the filters, they provide a rough amplitude equalization of the cable response over the appropriate frequency band, for example, approximately 20 kHz to 110 kHz upstream and approximately 160 kHz to 1 MHz downstream. The choice of frequency bands is, preferably, 20 kHz to 110 kHz for the upstream direction and 160 kHz to 1.1 MHz for the downstream direction.

If POTS need not be supported, then the load coils are superfluous and can be left “open”. Further, if the need for load coils is obviated, the separation of the units becomes a design parameter, independent of load coil placement. A suitable separation of Extenders in this situation is between 7 and 12 kft, and the unit can then be referred to as a “Mid-Span Extender”. Clearly, the gains required for the mid-span extender are commensurate with the expected separation.

An ADSL Repeater is well suited for providing ADSL services over long loops which may have been precluded based on loop length and presence of load coils. As described it is a simple mechanism for amplifying the upstream and downstream signals, compensating for the loss in the subscriber loop cable. Separating repeaters by approximately 6000 feet is appropriate since this the nominal distance between points on the cable where load coils were introduced in the past. Cross-over networks based on highpass and bandpass filters can define the upstream and downstream bandwidths used by the DMT-based ADSL units at the CO and CPE operating in a frequency-division duplex mode.

Installing equipment in the cable plant introduces two important considerations. One is the need to provide power. The second is to provide the means to verify operation and isolate problems.

Subscriber loop cable usually comes in bundles of 25 pairs. That is each bundle can provide service to 25 telephone lines. One embodiment of the invention can use the 25 pairs to provide just 20 ADSL connections. This leaves 4 pairs to carry power for the repeaters, and 1 pair to carry control information.

Each 25-pair “repeater housing” can include one controller (microprocessor) and modems that convert the digital control information to (and from) analog for transport over the control pair. These controllers can operate in a “daisy chain” which allows the central office end to query for status, or control the operation of, any repeater housing in the path. For long loops, those exceeding 18 thousand feet, there may be as many as 4 or 5 (or more) repeater housings connected in series (approximately 6000 feet apart). The control information will include commands for maintenance and provisioning information.

The provisioning information relates to the mode of operation of each of the 20 pairs of cable that carry ADSL. One mode is “normal”, where the repeater is operating and the load coils are in the circuit. Another mode is “no-ADSL-repeater” wherein the repeaters are not part of the circuit. This latter mode has two “sub-modes”. The load-coils may be in the circuit or be removed. The last sub-mode is appropriate if the loop is actually short and we do not need the repeaters and the load coils need to be removed. Of course, other modes of operation can be conceived of.

For test and maintenance purposes, the central office end needs to be capable of forcing any one chosen repeater (on the subscriber loop under test) to enter a loop-back state. That is, a test signal sent from the central office is “looped back” at the chosen repeater and the condition of the loop up to that chosen repeater can be validated. Other test and maintenance features must be provided to support the operating procedures of the phone company.

For providing loop-back through the repeater, the following approach can be used. It can be appreciated that the upstream and downstream signal bands are disparate and non-overlapping. Thus, the notion of loop-back is not simple. One approach can use a two-tone test signal that is within the downstream spectral band. For example, the tone frequencies could be 200 kHz and 250 kHz. When commanded to go into loop-back, the designated repeater introduces a nonlinear element into the circuit. The nonlinear element will create different combinations of the sums and difference frequencies. In particular, the nonlinear element can generate the difference frequency, 50 kHz in the example cited. This signal is within the frequency band of the upstream direction and thus can be looped back. The central office end can monitor the upstream path for this (difference) frequency and thus validate the connectivity up to the repeater in loop-back state.

The form of extender where load coils are not being replaced is the mid-span extender. Placement of a mid-span extender is not constrained by the placement of load coils but, as a matter of practice, the phone company usually has a manhole or equivalent construction where load coils are (normally) situated and these locations would be logical places for deployment of a mid-span extender as well. When a mid-span extender is employed, the load coil removal would follow normal telephone company practice.

The basic circuit outline 500 of the extender unit is shown in FIG. 5. The extender unit includes a first 2w-4w and a second 2w-4w. For the case of a “load coil replacement”, the 88 mH inductors 510 would be present and the gains adjusted for compensating for (roughly) 6000 feet of cable. The same circuit arrangement would apply to the mid-span extender case wherein the 88 mH coils would not be present and the gains adjusted for X feet of cable (X could be in the neighborhood of 10,000 feet).

The invention can include addressing the problem of trouble-shooting and fault location. When a telephone company deploys equipment, they typically require that alarms be generated whenever a fault is detected so that personnel can be dispatched to fix the underlying problem. But, in some cases, a fault is detected only when there is a customer complaint or during routine maintenance operations. It is clearly beneficial to include, in the normal operation of equipment, sensors or equivalent functionality, that continually monitor the health of the equipment and raise alarms if deteriorating circumstances are detected.

A useful method for monitoring the health of the repeater(s) (aka extender(s)) during actual operation can be incorporated into existing DSLAM (“Digital Subscriber Line Access Multiplexer”) equipment. The DSLAM is the equipment in the telephone company central office that contains the “ATU-C”, or central office ADSL modem. The “ATU-R”, or remote end, is incorporated in the subscriber-end ADSL equipment. The invention can thus be deployed using existing equipment, albeit with a minor modification.

The invention can include fault location tone generation. More specifically, the invention can include fault location tone generation at the repeater and/or extender.

During initialization the ATU-C can send a variety of tones towards the ATU-R. The frequencies of these tones can be between, for example, approximately 180 kHz and approximately 220 kHz. During normal operation, when actual data is being transmitted, one particular frequency, for instance specifically 276 kHz, can be transmitted by the ATU-C as a pilot, allowing the ATU-R to maintain frequency synchronization. The ADSL repeater can monitor the signal power over the frequency band between approximately 160 kHz and approximately 300 kHz. During normal operation there will always be significant signal strength in this band. Provided the signal strength is above a predetermined threshold, the repeater can add a locally generated tone to the upstream signal. The frequency of the tone is chosen as one of a plurality of frequencies, for example 4 frequencies for instance, one of the set {12.9375 kHz, 17.25 kHz, 21.5625 kHz, 25.875 kHz}. Of course, the invention is not limited to these particular frequencies. Absence of the tone indicates a problem between the central office up to and including the repeater.

If there are 4 tones available, up to 4 repeaters can be monitored by the detection circuitry in the central office. It is unlikely that a situation requiring more than 4 repeaters will be encountered. In fact, the most likely situation is the case with just a single repeater. A given repeater can be pre-assigned one of the set of available frequencies based on its location. It is advisable that the highest frequency be assigned to the repeater furthest from the central office; further, it is advisable that for any given deployment, the higher frequencies are chosen; further it is advisable to, if possible, leave the highest frequency unused, in order to maximize the “distance” between frequency band carrying actual ADSL data and the fault-location tone. Thus, in a single repeater case where the set is as described above, the repeater should be set to return 21.875 kHz; in a two repeater scenario, the closer repeater should be set to 17.5 kHz and the further repeater should be set to 21.875 kHz. The reason for assigning the frequencies in this manner is that the repeaters may inherently have a high-pass nature because of transformer coupling. Since the signal from the further repeater traverses the repeater that is closer in, it is advisable to make the further repeater the higher frequency to minimize the attenuation encountered. The choice of frequency can be accomplished via a dip-switch setting (or equivalent) in the repeater at the time of installation.

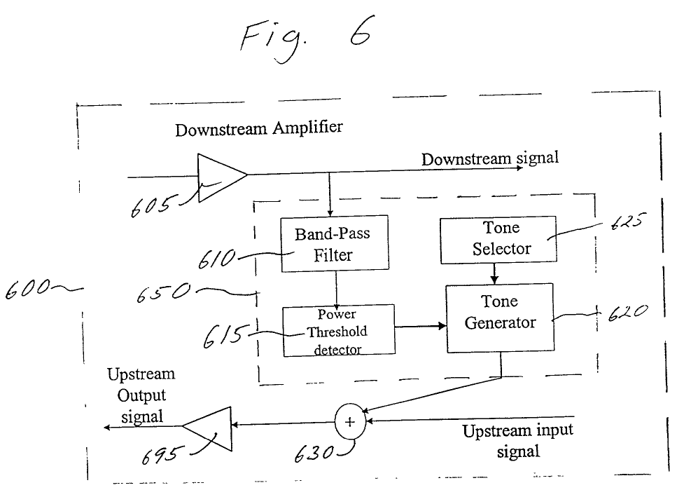

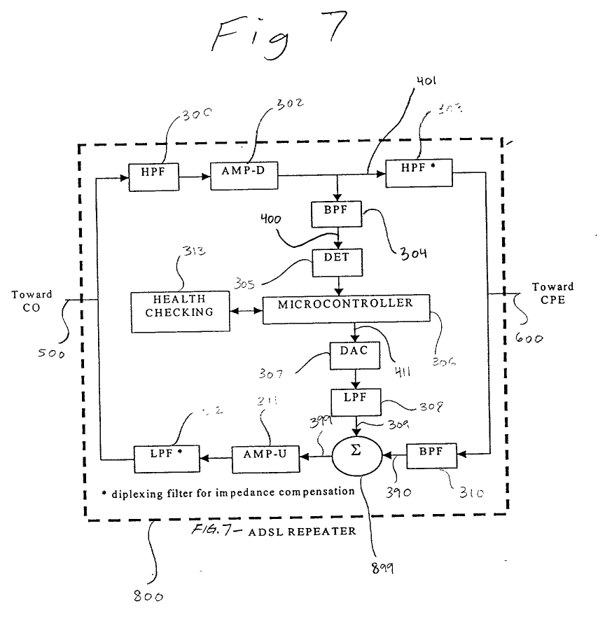

An example of the invention is depicted in FIG. 6. A repeater 600 (aka extender) includes a fault location tone generation module 650. For simplicity, only the functional entities related to the detection of downstream power and upstream tone insertion are shown.

Referring to FIG. 6, a downstream input signal is boosted by a downstream amplifier 605 on a downstream half of the loop resulting in a downstream output signal. A band-pass filter 610 is coupled to the downstream half of the loop resulting in a downstream output signal. A power threshold detector 615 is coupled to the band-pass filter 610. A tone generator 620 is coupled to the power threshold detector 615. A tone selector 625 is coupled to the tone generator 620. The tone selector 625 can be a dip switch. An addition circuit 630 is coupled to the tone generator 620. An upstream amplifier 695 is coupled to the addition circuit 630. An upstream input signal is boosted by the upstream amplifier 695 on an upstream half of the loop resulting in an upstream output signal.

In FIG. 6 we show the amplification stage used for the downstream direction. The output of the amplifier 605 is monitored using the band-pass filter 610 and power detection circuitry. Thus, the power of the downstream signal within the band 180 kHz to 300 kHz can be estimated. This power is compared with a predetermined threshold to control the amplitude of the tone generator 620 output. The tone generator 620 output is summed with the incoming upstream signal coming from the subscriber side and the combination is sent upstream towards the central office. The frequency of the tone can be selected at the time of installation. This is a simple but elegant method for monitoring the health of the ADSL repeater(s) at the central office. Clearly, several variations can be postulated and the choice of how complex an approach for fault location is to be chosen should be influenced by economic considerations.

For example: If we know a priori that there will be a limit of 2 repeaters, then each repeater could be assigned two tones. With some increase in complexity of the control circuitry, 4 states can be established with two tones (each is either ON or OFF). Since two states are “BAD” and “GOOD”, the remaining two states can be used to signal deteriorating conditions allowing the telephone company to initiate proactive maintenance procedures.

Rather than having a binary state for the fault-location tone, “ON” or “OFF”, the control mechanism can vary the strength of the tone. Since under normal conditions the attenuation between the repeater and the central office is a nominally fixed value, a variation in tone level can be interpreted by the central office circuitry as an (potential) problem indicator.

If equipment at the central office external to the DSLAM is provided for maintenance and trouble-shooting, then the limitations on the choice of frequencies imposed by the DSLAM are removed. More specifically, there would be no constraint on the frequencies other than they must lie outside the frequency band being used for ADSL transmission.

The invention can also utilize data processing methods that transform signals from the digital subscriber loop to actuate interconnected discrete hardware elements. For example, to change tone generation parameters and/or remotely fine-tune (gain adjustment and/or band-pass adjustment) and/or reconfigure (downstream/upstream reallocation) repeater(s) after initial installation using network control signals sent over the DSL.

Remote fault isolation of repeatered T1 span lines has a long standing tradition of use in reducing time and cost associated with discovery and repair of root cause failures. The method of fault isolation typically involves transmission of a unique signal from the CO which may be called a loopback command, specific in some manner (e.g. frequency or coding) to a particular repeater in the chain, which then (if capable of receiving the signal) sends a response, which may be called a loopback response, back to the CO. (Technically the term loopback implies that the incident signal is retransmitted in like form, but here we will not make that a requirement.) Reception of the correct response may be considered as an indication that the fault lies farther away from the CO than the responding repeater.

The likely future existence of repeatered ADSL lines, possibly with multiple repeaters, raises the prospect of a similar need for remote fault isolation. This document describes three approaches for ADSL system design and operation that may provide the capability required. All three approaches use frequency-division duplexing (FDD) techniques in the repeater to separate the upstream and downstream frequency bands, and all approaches respond to the CO with frequencies which are specific to the particular repeater responding. The three approaches differ in the nature of the loopback command signal from the CO to the repeater. Clearly, given no limitations of power, cost and size in the repeater design, a loopback methodology of arbitrary complexity and capability may be envisioned. However, in practice limits do apply, and so the challenge is to provide the maximum capability at the lowest power, cost and size possible, with the highest reliability. The best tradeoff of this sort is often achieved when increased capability is manifested in software, not hardware.

It is assumed that the ADSL line is DC-powered at the CO in a manner which does not interfere with AC signal coupling to/from the DSLAM. The maximum line power per repeater is constrained by the chosen open-circuit voltage, the number of repeaters, and the power dissipated in the line resistance. Thus power is at a premium in each repeater.

The upstream and downstream bands are each divided into several sub-bands centered on a sequence of carrier frequencies at integral multiples of 4.3125 kHz. The upstream bands, or tones, usually start at 6*4.3125 kHz and extend no higher than 29*4.3125 kHz, and the downstream tones usually start around 37*4.3125 kHz and extend no higher than 256*4.3125 kHz. (The multiple, or index, will henceforth be called “N”.)

Since the DSLAM at the CO is constrained by filtering to provide only downstream tones to the repeaters, a loopback signal (i.e. command) generated by the DSLAM must be derived from the tone set N=37 to 256. Conversely, only upstream tones can get back from the repeater into the DSLAM, so the loopback response must be derived from the tone set N<30. (A simple loopback command could also be provided by reversing the power polarity of line power, and full-wave rectifying the power at the repeaters, but that introduces problems of corrosion risk and either noise spikes or repeater resetting, and will not be explored here.)

The detection and interpretation of the loopback command, and the generation of the loopback response, are inherently secondary functions of the repeater, whose primary function is high-fidelity independent amplification of signals in both upstream and downstream directions of transmission. Therefore, the circuitry required to perform these secondary functions will be additional to the main circuits, but connected to them.

Given that the purpose of the loopback response is to indicate correct operation of the repeater which generates it, it is preferable that both the detection of the loopback command, and the generation of the response, be done as far downstream as possible within the repeater, such that the maximum amount of repeater circuitry is verified.

The loopback command must be passed downstream from repeater to repeater such that all repeaters on the line may receive it. Similarly, the response of every repeater must be passed upstream from repeater to repeater all the way to the CO.

Ideally, the loopback command should not require or cause interruption of showtime; however, this desire may be inconsistent with low power operation in some cases, given that command interpretation and response may be greatly complicated if they are constrained to function correctly during showtime. It is also inconsistent with the need to respond upstream to the CO within the same upstream band that is used during showtime. If showtime must be interrupted, then the customer premises equipment (CPE) must be isolated from the CPE-end repeater's upstream path during loopback responses, such that it doesn't interfere.

The loopback command should be correctly interpreted with high reliability, especially in methods which cause the repeater to interrupt showtime while generating a loopback response. In such cases, the probability of “false positives” must be extremely low.

The loopback responses should allow for precise identification of which repeater on the line is responsible.

### METHOD 1: AUTONOMOUS LOOPBACK

In this method, the loopback command is simply the presence of downstream power, in a relatively narrow band containing the pilot tone N=64, which should always be present during normal operation (“showtime”). A detector compares the downstream power within the pass band against a threshold level that should be exceeded under worst case conditions of line attenuation (which depends on repeater spacing, wire gauge, and temperature). If the downstream power level exceeds the threshold, (and, optionally, if other continuous health checks indicate OK) then an upstream response tone, with a fixed index N which is different for each repeater on the line, is generated by oscillator and/or synthesizer and transmitted upstream to the CO. Since the loopback response should not interfere with showtime, the response tones should have indices out of the normal range of upstream indices, which realistically means less than 6. The overall transfer efficacy of such low frequencies back to the DSLAM may be degraded substantially, so it is probable that for a two-repeater case the optimum choice of indices would be 4 and 5 to minimize the degradation.

This method is the simplest of all, and has no obvious prospects for a variety of loopback commands.

A slight enhancement of this method would be to make the amplitude of the loopback response tone dependent on the power level received in the narrow band around N=64, such that a greater power level produces a greater amplitude of loopback response tone.

Another possible variation would be to generate the response tone via downconversion of the N=64 band to directly produce the loopback response tone.

### METHOD 2: NON-AUTONOMOUS BINARY AM LOOPBACK

In this method, the DSLAM encodes a loopback command as binary amplitude modulation at a predetermined fixed symbol rate, applied to tones within a portion of the downstream band not containing the pilot tone N=64. The AM is detected and sampled such that the binary modulation sequence is recovered. Data recovery accuracy may be based on either symbol clock recovery or oversampling; also, unique code sequences should be incorporated in the modulation sequence at start and/or finish as required, to guarantee not only that the message is real (not noise), but that it is correctly interpreted from the first bit to the last. Given the uncertainty of the received power level at the repeater, either an AGC circuit should be used to adjust the signal level according to a fixed detector threshold value, or the message should be constrained to contain on average equal numbers of 1's and 0's, and the detector threshold should be set to near the average received signal level. Either way would provide for sufficient margin at the detector input. The received message is then interpreted, and would generally be of the form “if X is true, then respond with tone Y” where Y is predetermined by the repeater identity. The statement “X” would either be true by default, in the case of a forced response, or be determined by a health verification such as “the board temperature is above T degrees Centigrade”. By means of repeated loopback commands and responses, much information may be learned about the operational state of each repeater. A great variety of different commands may easily be encoded within a suitably long loopback message, at no significant added hardware cost.

The loopback response tone is generated by an oscillator and/or synthesizer, and is specific to the repeater identity.

This method requires that showtime be interrupted during the loopback command and response.

### METHOD 3: NON-AUTONOMOUS BEAT-TONE-PLL LOOPBACK

This method interprets the loopback command as the presence (with sufficient and roughly equal power) of only two downstream tones (say the pilot N=64 and one other tone), with all other downstream tones being absent. One way to detect this would be to perform AM detection within the downstream band, and lock a slow-response PLL with slow-in, fast-out lock detector to the demodulated AM (which would be at the beat or difference frequency between the two downstream tones). During normal showtime, the PLL lock detector would continuously indicate out-of-lock because of the incoherent nature of the AM present on the signal; however, the loopback command state described above would produce a pure AM frequency to which the PLL could lock. This state would then cause the repeater to retransmit a response tone which would be derived from either the beat tone directly, or the PLL output (which would be a repeater-specific multiple of the beat tone) or a submultiple thereof. In any case, the response tone would need to be unique to the repeater identity.

The prospects for a variety of loopback commands may be limited with this approach, since there should be no modulation on the downstream tones to interfere with the AM detection of a pure beat tone. Conceivably different downstream frequencies could be used for different commands, but this rapidly complicates the hardware design.

This method clearly also requires interruption of showtime during the loopback command and response.

### EXAMPLE EMBODIMENTS

Two of the above methods, 1 and 2, shall now be further illustrated in the context of particular embodiments. In each of these embodiments, a low-power microcontroller (aka microprocessor) is used to recognize the loopback command, and also to generate the response tone. For simplicity, it is assumed that the maximum number of repeaters on the line is two; although more repeaters will clearly require more power from the line, these methods are otherwise equally applicable to systems of greater numbers of repeaters.

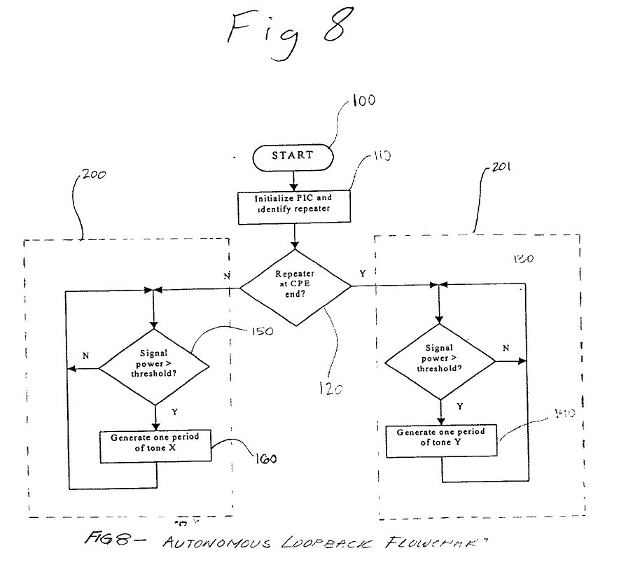

Referring to FIG. 7, a block diagram of an ADSL Repeater suitable for application in Methods 1 and 2 described above is shown. Downstream signals are filtered by a high pass filter HPF, amplified by a downstream amplifier AMP-D, and (after passing through a diplexing filter) applied to the next segment of line. A similar sequence takes place in the upstream direction. The microcontroller monitors downstream power (post-amplification) within a specific spectral band, and (based on the method in use) consequently decides whether or not to inject a specific response tone into the upstream path (pre-amplification). Health verification circuitry provides additional information to the microcontroller for use in making its decision.

Still referring to FIG. 7, a repeater 800 can be coupled between a CO and a CPE. A repeater input 500 can be coupled to both a high pass filter 300 and a low pass diplexing filter 312. The high pass filter 300 can be coupled to a downstream amplifier 302. The downstream amplifier 302 can be coupled to both a high pass diplexing filter 303 and a first band pass filter 304. The first band pass filter 304 can be coupled to a detection system 305. The detection system 305 can be coupled to a microcontroller 306. The microcontroller can be coupled to both a health checking unit 313 and a digital to analog converter 307. The digital to analog converter 307 can be coupled to a low pass filter 308. The low pass filter can be coupled to a first summer input 309. The high pass diplexing filter 303 can be coupled to both a repeater output 600 and a second band pass filter 310. The second band pass filter 310 can be coupled to a second summer input 390. A summer output 399 can be coupled to an upstream amplifier 311. The upstream amplifier 311 can be coupled to the low pass diplexing filter 312.

Again referring to FIG. 7, a downstream signal may be presented at a repeater input 500. The downstream signal can be filtered by a high pass filter 300 and then amplified by a downstream amplifier 302. A sample of the filtered and amplified downstream signal 400 can then be obtained via a first band pass filter 304. The remainder of the filtered and amplified downstream signal 401 can be filtered by a high pass diplexing filter 303 for impedance compensation and then output at a repeater output 600. The sample of the filtered and amplified downstream signal 400 can then be passed through a detection unit 305. The detection unit 305 can send the sample of the filtered and amplified downstream signal 400 along with other information to a microcontroller 306. The microcontroller 306, together with a health checking unit 313, can test the sample of the filtered and amplified downstream signal 400 for certain signal characteristics. Depending on the nature of the sample of the filtered and amplified downstream signal 400, the microcontroller 306 may output a digital signal 411, which can then be converted to an analog signal by a digital to analog converter 307. The analog signal can then be filtered by a low pass filter 308 to eliminate unwanted harmonics. The output of the low pass filter 309 can then be input at a summer 899. An upstream signal can be filtered by a second band pass filter 310 and then can be input at the summer 899. The summer can combine the output of the low pass filter 309 with the output of the second high pass filter 390 to produce a combined upstream signal 399. The combined upstream signal 399 can then be amplified by an upstream amplifier 311 and filtered by a low pass duplexing filter 312 for impedance compensation. The output of the low pass duplexing filter 312 can then be sent upstream to the CO from the repeater.

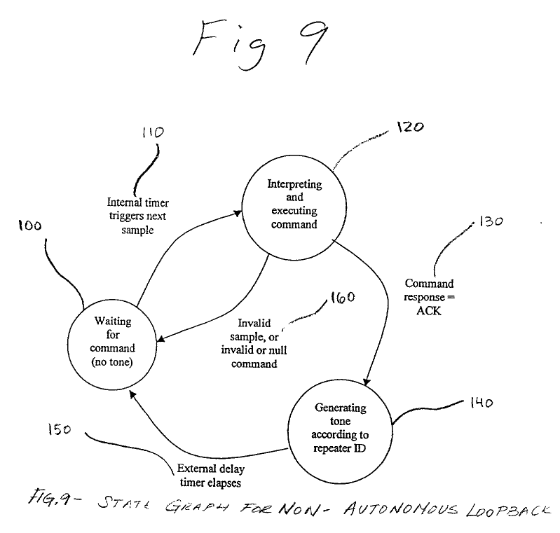

Referring to FIG. 8, an autonomous loopback flowchart that closely resembles the techniques of method 1 described above is shown. When the repeater is first turned on, the microcontroller undergoes a power-on reset, and then proceeds to execute its program from the start 100. In addition to initializing internal registers after reset, it checks a status line to verify the identity of the repeater of which it is a part 110. Depending on its identity, which in this case has two possible values depending on whether the repeater is the one closest to the CPE 120, the microcontroller can decide to execute one of two similar loops 200 and 201. In each of these loops 200 and 201, the microcontroller first verifies that the downstream power detector indicates a power level exceeding its threshold 150 and 130. If so, then the microcontroller will generate exactly one complete period of digital samples of a sinusoid, as closely as can be approximated by its output port 160 and 140. The two loops 200 and 210 differ only in the frequency of the sinusoid thus generated. Naturally the frequency is controlled not only by the number of sample points per period, but also by the frequency of the clock signal provided to the microcontroller.

The microcontroller's digital output can be low-pass filtered to attenuate undesired harmonics and spurious noise, and can then be injected into the upstream signal path for transmission to the CO.

Referring to the Appendix, attachment 1 shows an assembly code that can be used to realize method 1 in a Microchip 16C621A PIC microcontroller. Still referring to the Appendix, attachment 2 shows an assembly code that can be used to realize methods 2 and/or 3 in a Microchip 16C621A PIC microcontroller.

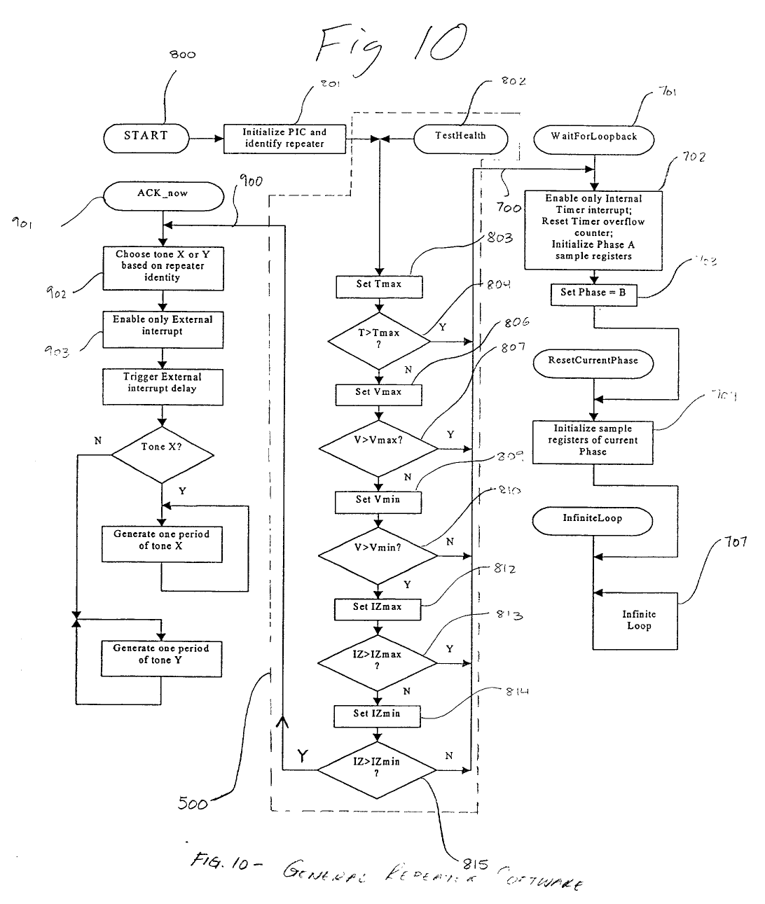

FIG. 9 shows a state machine that can be used to implement non-autonomous loopback, as described by method 2 above. This is a simplified state machine of the non-autonomous binary AM loopback of method 2. In this embodiment, it is assumed that the microcontroller is incapable of simultaneously generating a response tone and interpreting a loopback command (a constraint which is based in reality when power must be conserved), so a separate timer circuit, external to the microcontroller, is necessary to keep it from generating the response tone indefinitely. Suppose the microcontroller is waiting for a command 100. (This is the normal and required state during showtime.) An internal timer can generate interrupts at a programmed rate, and at each interrupt another sample of the power detector can be taken 110. The sequence of samples up to that point may be examined for compatibility with predetermined requirements of code sequences and parity 120. If the sequence matches these requirements, and if the repeater is the one addressed by the command, and if the correct response to the command is a positive acknowledgement (ACK) 130, then the microcontroller can first trigger the external delay timer, and can then proceed to generate a response tone digitally in a continuous loop 140. When an external delay expires 150, the microcontroller receives an interrupt, the response tone ceases, and the circuit may wait for the next loopback command. If the sequence does not match the requirements of code sequences and parity, or if no command is detected, the circuit may not generate any response tone and can go back to waiting for a loopback command 160.

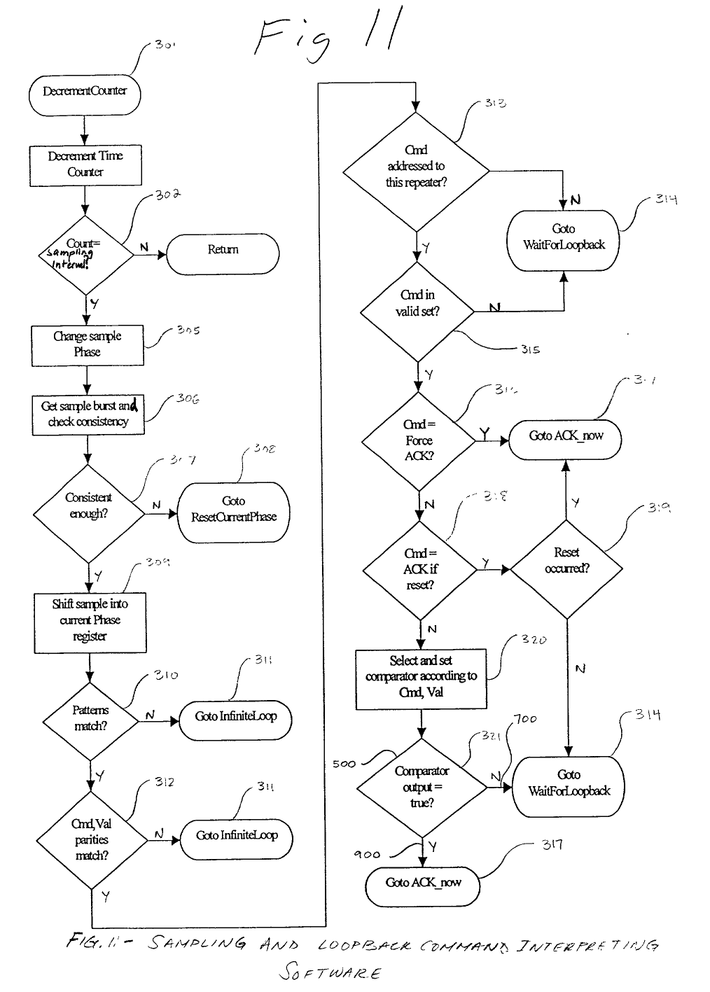

FIGS. 10-12 illustrate the flowchart for this method of operation. In this embodiment, the health checking includes the temperature, the supply voltage, and the regulator shunt current. Two independent, alternating phases of samples are stored, such that one phase or the other will not incur a slip during a loopback command sequence.

Referring to FIG. 10, a flowchart describing functions carried out by a microcontroller that may be used in a repeater for a non-autonomous loopback fault isolation system is shown. As shown, the microcontroller carrying out the selected functions may be employed in both repeaters of a two-repeater (hence two-tone) extended ADSL with loopback for fault isolation. Upon initial power-up, a microcontroller executes a subroutine START 800. Upon entering the subroutine START 800, all registers, index registers, program counters, and condition code registers are initialized to default values according to the specific identity of the repeater 801.

A subroutine TestHealth 802 is then executed by the microcontroller. In this example the entire subroutine TestHealth 802 may be referred to as a comparator 500 with a true output 900 and a false output 700. The subroutine TestHealth 802 instructs the microcontroller to carry out tests on sample data stored in sample registers. The sample data stored in the sample registers may be filtered out of a downstream data flow by the repeater, or it may be generated by the repeater itself. Tests to be carried out on the sample data in FIG. 10 includes a temperature test, a supply voltage test, and a regulator shunt current test. Of course, different tests may be carried out in different sequences than described below. The invention is not limited to any particular test or sequence of tests. Upon entering the subroutine TestHealth 802, the microcontroller can first carry out a temperature test, to determine whether a certain sample temperature is below a maximum allowable temperature. An upper limit temperature Tmax 803 may be loaded into a register. Then, a sample temperature, stored in a sample register, may be compared to Tmax 803 to determine if the sample temperature is below the maximum desired temperature 804. If the desired temperature condition is met, then the microcontroller can load a predetermined maximum desired voltage into a register 806. A sample voltage stored in a sample register may then be compared to the maximum desired voltage to determine whether the sample voltage is less than the maximum desired voltage 807. If the sample voltage is less than the maximum desired voltage, then the microcontroller can load a minimum desired voltage into a register 809. The sample voltage can then be compared to the minimum desired voltage to determine whether the sample voltage is higher than the minimum desired voltage 810. If the sample voltage is higher than the minimum desired voltage, then the microcontroller can load a maximum desired shunt current into a register 812. A sample shunt current can then be compared to the maximum desired shunt current to determine whether the sample shunt current is less than the maximum desired shunt current 813. If the sample current is less than the maximum desired shunt current 813, then the microcontroller can load a minimum desired shunt current into a register 814. The sample shunt current can then be compared to the minimum desired shunt current to determine if the sample shunt current is higher than the minimum desired shunt current 815. If the shunt current is higher than the minimum desired shunt current, then the subroutine TestHealth 802, and hence the comparator 500, can output a true response 900. If any one of the desired conditions tested above are not met, then the subroutine TestHealth 802, and hence the comparator 500, can output a false response 700.

If the comparator 500 output is true 900, the microcontroller can execute a subroutine ACK_now 901. The microcontroller can execute instructions to decide the type of tone it is to output based on repeater identity 902. Then, the microcontroller can enable only external interrupts, ensuring that the generated tone's duration can only be regulated by a external timing device 903. The microcontroller can output the correct tone (X or Y as shown in FIG. 10) for as long as the external timing device allows. Upon receiving an external interrupt, the microcontroller can terminate the subroutine ACK_now 901 and execute a subroutine WaitForLoopback 701.

If the comparator 500 output is false 700, or the subroutine ACK_now 901 has been interrupted by the external timing device, the microcontroller can execute the WaitForLoopback subroutine 701. First, the microcontroller can enable only internal timer interrupts 702 to ensure that the subroutine can only be interrupted internally at internally-predetermined times at which samples may be taken which may consist of a loopback command from the CO. The microcontroller may initialize phase A sample registers. Then, a different set of samples may correspondingly be used to initialize phase B sample registers 703 and 704. After both phase A and phase B registers are initialized, the subroutine WaitForLoopback 701 can enter a loop 707 which can only be terminated when a loopback command is recognized by the microcontroller in the repeater is addressed by the command. When such an internal timer interrupt occurs.

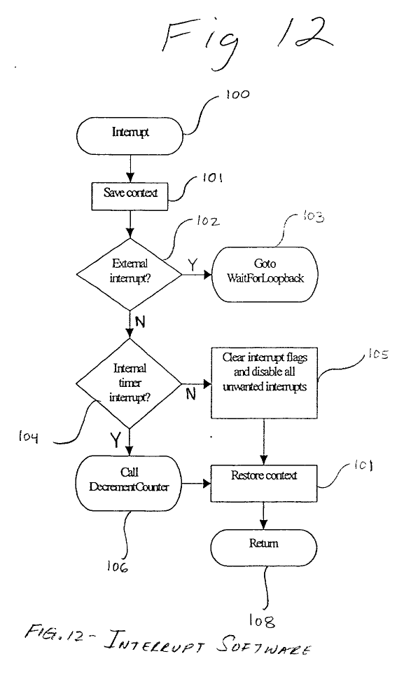

FIG. 11 illustrates a flowchart that describes a program that can be implemented using a microcontroller to first acquire sample data from downstream signals and then to interpret various commands sent to a repeater from a central office. When a loopback command is received by the repeater, a subroutine DecrementCounter 301 can use the microcontroller's internal clock to measure a sampling interval at which the repeater acquires data from downstream signals. If a time count 302 is not equal to the sampling interval, the program can return to the origin of the subroutine DecrementCounter 301 to continue counting. When the time count 302 is equal to the sampling interval, the microcontroller can change a sample phase 305, acquire a sample burst, and check the sample consistency 306. If the acquired sample is not consistent enough, the program can branch to a subroutine ResetCurrentPhase 308 to clear all samples for the same phase. If a consistent sample was obtained, the microcontroller can shift the sample into a current phase register 309. The sample may then be compared to predetermined desired code sequences and bit parities 310 and 312. If the sample does not match the desired code sequences and bit parities, the program can branch to a subroutine InfiniteLoop 311, without generating a loopback tone. If the sample matches the desired code sequences and bit parities, the microcontroller determines whether the loopback command is intended for a particular repeater 313 and whether the loopback command is in a valid set of commands 315. If the loopback command is not intended for that particular repeater, or the loopback command is not within the valid set of commands, the program can branch to a WaitForLoopback subroutine 314 where the microcontroller can wait to receive the next loopback command from the central office. If the loopback command is addressed to the repeater and it is in the valid set of commands, the microcontroller can interpret the nature of the loopback command and execute instructions accordingly. In this example, the microcontroller can first determine if the loopback command is a “force acknowledge” 316 command. If it is, then the program can branch to the ACK_now subroutine 317. If the loopback command is not a “force acknowledge” command, then the microcontroller can determine if the loopback command is an “acknowledge if reset” command. If it is, then the microcontroller can determine whether a reset has occurred 319. If a reset has occurred, the program can branch to the subroutine ACK_now 317. If a reset has not occurred, the program can branch to the WaitForLoopback subroutine 314. If the loopback command is not an “acknowledge if reset” command, then the microcontroller can select and set the comparator 500 (shown in FIG. 10) according to the loopback command 320. If the comparator 500 output is true, the program can branch to the subroutine ACK_now 317, where the microcontroller can generate a repeater response tone. If the comparator 500 output is false, the program can branch to the subroutine WaitForLoopback 314, where the microcontroller can wait to receive the next loopback command.

FIG. 12 shows a flow chart that describes an interrupt detection program that can be used to integrate both an external timing mechanism and an internal timing mechanism for use with the invention. If an interrupt occurs (external or internal timer), a microcontroller can execute a subroutine Interrupt 100. First, the context 101 under which the interrupt occurred can be saved. Then the microcontroller can determine whether the interrupt is an external interrupt 102. If it is an external interrupt, the program can branch to a subroutine WaitForLoopback 103. If the interrupt is not an external interrupt, the microcontroller can then determine if the interrupt is a internal timer interrupt 104. If it is not, then the microcontroller can clears all interrupt flags and disable all unwanted interrupts 105. If the interrupt is an internal timer interrupt, the program can call another program DecrementCounter 106. The subroutine Interrupt 100 can terminate by restoring the context 101 under which the interrupt occurred, and then returning to a caller subroutine 108.

The invention, along with appropriate software, can be used to implement a backup repeater system, wherein stand-by repeaters are switched into a DSL line if any normal operation repeater malfunction is sensed by the central office. This may ensure that the faulted subscriber line remains operational, routing data through the stand-by repeater. Also, with minor modifications to the examples described above, other diagnostic tests can be performed using the invention. Thus the invention can be used to pinpoint faults in a DSL provided that the correct (affected) signal characteristics are being monitored by the central office.

### CONCLUSION

In a repeatered line, whether T1, ADSL, or some other protocol, remote loopback capability is necessary for reducing time and cost associated with fault detection. The three methods described are possible means by which this feature can be realized in an ADSL repeatered line. In general, the methods are either autonomous, requiring CO monitoring but no intervention, and non-autonomous, in which the CO initiates a loopback sequence. The non-autonomous methods will generally provide more information to the CO. A full implementation and description of any method would have to include an algorithm for deriving the most likely root cause of a failure from the entire set of information gathered, some of which may come from sources other than the repeater itself (such as power supply monitoring at the CO); however, this disclosure makes no attempt to elucidate such an algorithm.

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

### PRACTICAL APPLICATIONS OF THE INVENTION

A practical application of the invention that has value within the technological arts is local digital subscriber loop service. Further, the invention is useful in conjunction with digital subscriber loop networks (such as are used for the purpose of local area networks or metropolitan area networks or wide area networks), or the like. There are virtually innumerable uses for the invention, all of which need not be detailed here.

### ADVANTAGES OF THE INVENTION

A digital subscriber loop repeater, representing an embodiment of the invention can be cost effective and advantageous for at least the following reasons. The invention permits DSL to be provided on long loops. The invention permits DSL to be provided on loaded loops. The “Transmux” scheme is superior to the agreed upon standard, called “DMT”, especially in situations where the separation of upstream and downstream traffic is achieved using filters; that is, in the Frequency Division Duplexing (or FDD) mode of operation. The new scheme is especially appropriate for providing ADSL over long subscriber loops which require “repeaters” or “extenders”. While conventional DSL installation requires that all load coils be removed from a loop, the invention can include the replacement of these load coils with what can be termed an “ADSL Repeater” or “ADSL Extender”. In particular, using ADSL Repeaters (in place of load coils), one particular form of ADSL that uses the technique of frequency-division-duplexing can be provided to customers over very long loops. A variation of the Repeater is the “Mid-Span Extender” where the unit is not necessarily placed at a load coil site. In addition, the invention improves quality and/or reduces costs compared to previous approaches.

All the disclosed embodiments of the invention disclosed herein can be made and used without undue experimentation in light of the disclosure. Although the best mode of carrying out the invention contemplated by the inventor(s) is disclosed, practice of the invention is not limited thereto. Accordingly, it will be appreciated by those skilled in the art that the invention may be practiced otherwise than as specifically described herein.

Further, the individual components need not be formed in the disclosed shapes, or combined in the disclosed configurations, but could be provided in virtually any shapes, and/or combined in virtually any configuration. Further, the individual components need not be fabricated from the disclosed materials, but could be fabricated from virtually any suitable materials.

Further, variation may be made in the steps or in the sequence of steps composing methods described herein. Further, although the digital subscriber loop repeaters described herein can be separate modules, it will be manifest that the repeaters may be integrated into the system with which they are associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

1. Walter Y. Chen, DSL. Simulation Techniques and Standards Development for Digital Subscriber Line Systems, Macmillan Technical Publishing, Indianapolis, 1998. ISBN: 1-57870-017-5.

2. Padmanand Warrier and Balaji Kumar, XDSL Architecture, McGraw-Hill, 1999. ISBN: 0-07-135006-3.

3. “G.992.1, Asymmetrical Digital Subscriber Line (ADSL) Transceivers,” Draft ITU Recommendation, COM 15-131.

4. “G.992.2, Splitterless Asymmetrical Digital Subscriber Line (ADSL) Transceivers,” Draft ITU Recommendation COM 15-136.

5. Kishan Shenoi, Digital Signal Processing in Telecommunications, Prentice-Hall, Inc., Englewood Cliffs, N.J., 1995. ISBN: 0-13-096751-3.

6. The Electrical Engineering Handbook, CRC Press, (Richard C. Dorf et al. eds.), 1993.

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method, comprising:
obtaining a sample of a downstream signal conveyed along a signal path;
performing an analysis of the sample;
determining a presence or an absence of a fault in the signal path based on the analysis of the sample;
indicating a presence or an absence of a fault in the signal path by transmitting a diagnostic signal to an upstream node; and
if the presence of the fault is indicated, isolating a location of the fault as a function of the diagnostic signal.

2. The method of claim 1, wherein isolating includes identifying a cause of the fault as a function of the diagnostic signal.

3. The method of claim 1, wherein the absence of the fault in the signal path is indicated by the absence of a response signal.

4. The method of claim 1, wherein the upstream node includes a central office.

5. The method of claim 1, wherein the signal path composes a digital subscriber loop.

6. The method of claim 1, further comprising:
injecting the diagnostic signal into an upstream signal;
amplifying the upstream signal; and
transmitting the upstream signal to the upstream node.

7. The method of claim 1, further comprising:
generating a loopback command at the upstream node;
injecting the loopback command into the downstream signal;
transmitting the downstream signal from the upstream node via the signal path;
filtering the loopback command out of the downstream signal;
detecting the loopback command; and
executing the loopback command.

8. The method of claim 7, further comprising monitoring a characteristic of the downstream signal.

9. The method of claim 7, further comprising generating a loopback response signal as a function of both the loopback command and the characteristic of the downstream signal.

10. The method of claim 1, further comprising amplifying the downstream signal.

11. The method of claim 7, further comprising analyzing the loopback command for code sequence and parity characteristics.

12. The method of claim 11, wherein analysis of the loopback command is accomplished by executing a set of instructions on a data processor.

13. The method of claim 7, wherein the loopback command occupies a frequency band in common with the downstream signal.

14. The method of claim 9, wherein the loopback response occupies a frequency band in common with the upstream signal.

15. The method of claim 7, further comprising isolating faults in the signal path as a function of the loopback response.

16. The method of claim 7, further comprising frequency division duplexing a downstream frequency band and an upstream frequency band.

17. The method of claim 9, wherein a frequency band of the loopback response is specific to a repeater.

18. The method of claim 7, further comprising:
filtering out the loopback response from the upstream signal; and
detecting the loopback response at the upstream node.

19. An apparatus, comprising:
a first band pass filter;
a detection unit coupled to the first band pass filter;
a data processor coupled to the detection unit;
a health checking unit coupled to the microcontroller;
a digital to analog converter coupled to the microcontroller;
a low pass filter coupled to the digital to analog converter; and
a summer coupled to the low pass filter.

20. The apparatus of claim 19, further comprising:
a high pass filter;
a downstream amplifier coupled to the high pass filter;
a high pass diplexing filter coupled to the downstream amplifier;
an upstream amplifier coupled to the summer;
a low pass diplexing filter coupled to between the upstream amplifier and the high pass filter; and
a second band pass filter coupled between the high pass diplexing filter and the summer.

21. The apparatus of claim 19, wherein the health checking unit includes at least one member selected from the group consisting of a temperature monitor, a signal power monitor, and a galvanometer.

22. The apparatus of claim 19, wherein the data processor includes a programmable logic device

23. The apparatus of claim 19, wherein the data processor includes a microcontroller.
